(19) United States
(12) Patent Application Publication
(10) Pub. No.: US 2018/0178342 A1
(43) Pub. Date: Jun. 28, 2018

(54) WORK TOOL POSITIONING SYSTEM

(71) Applicant: Caterpillar Inc., Peoria, IL (US)

(72) Inventor: Carey Dean Russell, Desford (GB)

(73) Assignee: Caterpillar Inc., Peoria, IL (US)

(21) Appl. No.: 15/842,102

(22) Filed: Dec. 14, 2017

(30) Foreign Application Priority Data
Dec. 23, 2016 (GB) 1622115.2

(51) Int. Cl. B23Q 17/22; B25H 1/00; G01C 9/04; G05B 19/402

(52) U.S. Cl. CPC B23Q 17/2241; B23Q 17/2208; B25H 1/0092; B23B 2270/32; G05B 19/402; G05B 2219/37423; G01C 9/04

(57) ABSTRACT

The disclosure provides a work tool positioning system for a work machine comprising a movable work tool. The work tool positioning system comprises a work tool mounted at an end of a movable arm. At least one proximity sensor is provided for providing a proximity signal indicative of a distance between the at least one proximity sensor and an object in front of the proximity sensor. A processor is configured to receive the proximity signal and to calculate a clearance distance between a reference location on the work tool and an object in front of the proximity sensor. An alert system is provided for alerting an operator of the work machine. The processor is configured to activate one or more alerts when the clearance distance is greater than or equal to a first threshold unloading distance.

### TECHNICAL FIELD

This disclosure is directed to a work tool positioning system, and in particular to a work tool positioning system for use with a work machine.

### BACKGROUND

Work machines, such as backhoe loaders, front end loaders, and other types of loaders, are frequently fitted with a front end work tool, such as a loader bucket or a loader fork. The work tool may be mounted at the end of a movable arm, which may be raised and lowered. The work tool may typically be adapted to pick-up, carry, and unload a load. For example, a loader bucket may typically be used to transport materials, such as earth, around a worksite. A loader fork may typically be used to load, transport, and unload pallets.

A load may typically be transported with the work tool in a lowered position, for stability reasons. To unload materials from a loader bucket into a container, the work tool is typically raised and the work machine must approach the container to a near enough distance that the materials may be successfully unloaded into the container. Accurate positioning of the work machine and loader bucket is required to avoid spilling the materials over the side of the container and to avoid contacting the container, which may cause damage to a front end of the work machine. However, such accurate positioning may be challenging as the operator typically may not have good visibility of the position of the front end of the work machine or of the loader bucket.

### SUMMARY

The present disclosure provides a work tool positioning system for a work machine comprising a movable work tool, the work tool positioning system comprising: a work tool mounted at an end of a movable arm; at least one proximity sensor for providing a proximity signal indicative of a distance between the at least one proximity sensor and an object in front of the proximity sensor; a processor configured to receive the proximity signal and to calculate a clearance distance between a reference location on the work tool and an object in front of the proximity sensor; and an alert system for alerting an operator of the work machine; wherein the processor is configured to activate one or more alerts when the clearance distance is greater than or equal to a first threshold unloading distance.

By way of example only, embodiments of a work tool positioning system are now described with reference to, and as shown in, the accompanying drawings.

### BRIEF DESCRIPTION OF THE DRAWINGS

FIGS. 1 is a schematic side view of a work machine having as a front end work tool a loader bucket in a lowered position, in which work machine an embodiment of the system of the present disclosure may be employed;

FIG. 2 is a schematic front view of the work machine according to FIG. 1;

FIG. 3 is the side view of FIG. 1, with the front end work tool in a raised position; and

FIG. 4 is a schematic side view of a work machine having as a front end work tool a loader fork in a lowered position, in which work machine an embodiment of the system of the present disclosure may be employed.

### DETAILED DESCRIPTION

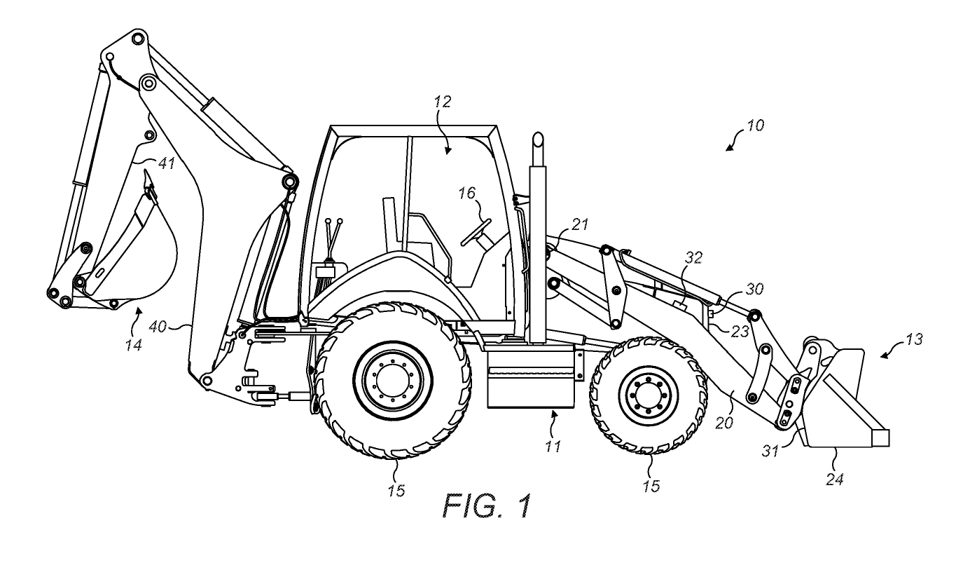

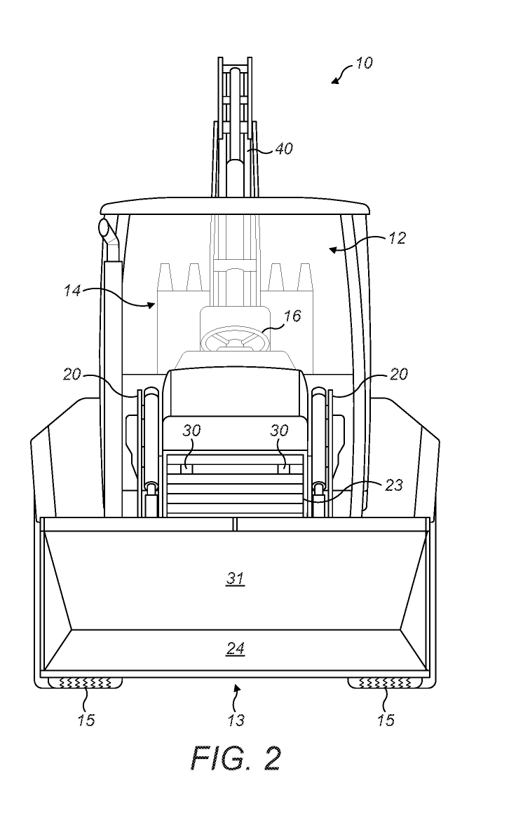

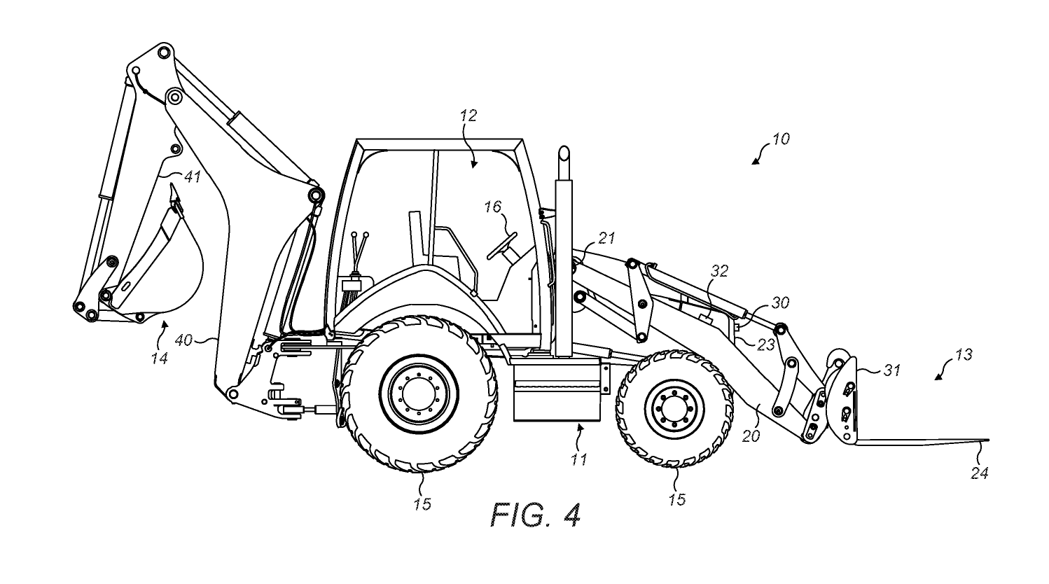

FIGS. 1 to 4 illustrate a work machine 10 that may comprise a body 11 having a cab 12. The work machine 10 may also comprise a front end work tool 13 at the front of the work machine 10, which may be movable relative to the body 11. As shown in FIGS. 1 to 3, the front end work tool 13 may comprise a loader bucket. However, the front end work tool 13 may be interchangeable with a number of alternative work tools, such as the loader fork shown in FIG. 4. The work machine 10 may further comprise a rear end work tool 14 at a rear end of the work machine 10 that may also be movable relative to the body 11.

Movement of the work machine 10 and of the front end work tool 13 may be controllable by an operator in the cab 12. The operator may control both ground propulsion of the work machine 10 and movement of the front end work tool 13 relative to the body 11.

Ground propulsion of the work machine 10 may be governed by devices and techniques that are well known in the art. In the case of the work machine 10 of FIGS. 1 to 3, ground propulsion is effected by four wheels 15. For example, movement of the machine forwards and backwards may be through delivering power from an engine of the machine to one or more of the four wheels 15 of the machine via a gearbox. The operator may control such using a combination of devices located inside the cab 12, which may include an accelerator pedal, a brake pedal, a clutch, and a gear shift stick. The work machine 10 may employ a manual, automatic, hydrostatic, or electric transmission. Movement of the work machine 10 left and right may be governed by rotating the front wheels 15 relative to a longitudinal direction of the body 11 of the work machine 10 whilst the work machine 10 is moving forward or backwards. The operator may control movement of the front wheels 15 left or right by moving a steering wheel 16 located inside the cab 12. Alternatively, ground propulsion may be effected by a track (not shown) instead of wheels 15.

Movement of the front end work tool 13 relative to the body 11 may, for example, be actuated hydraulically and controlled by one or more levers that may be located in the cab 12, such that the operator may operate them from the same position or a similar position as that for operating the controls that govern ground propulsion. Depending on the nature of the front end work tool 13 and the mechanism of connection to the body 11 of the work machine 10, the front end work tool 13 may be controllable to move relative to the body 11 of the work machine 10 with multiple degrees of freedom. The front end work tool 13 of FIGS. 1 to 3 may be connected to the body 11 via a pair of arms 20 that are each pivotally connected at a proximal end thereof to the body 11 of the work machine 10 at a first pair of pivots 21. The pivots 21 may share a common axis. The front end work tool 13 may be connected to a distal end of each arm 20 via a second pair of pivots (not shown).

A height of the front end work tool 13 relative to the body 11 of the work machine 10 (and hence, indirectly, relative to the surrounding ground), as well as the distance of the front end work tool 13 from a front end 23 of the work machine 10, may be governed by an angle of the pair or arms 20 at the first pair of pivots 21. An angle of the front end work tool 13 may be governed both by (a) the angle of the pair of arms 20 at the first pair of pivots 21 and (b) the angle of the front end work tool 13 relative to the pair of arms 20 at the second pair of pivots. For the purposes of this description, when discussing an angle of the pair of arms 20, unless otherwise stated, this refers to an angle relative to the body 11. Also for the purposes of this description, the front end work tool 13 may be described as horizontal when a bottom surface 24 of the front end work tool 13 is parallel to a plane defined by the surrounding ground on which the wheels 15 of the work machine 10 are situated. The front end work tool 13 may be described as having a downward angle when the bottom surface 24 of the front end work tool 13 is tipped forwards relative to the work machine 10 such that contents of the front end work tool 13 may fall under gravity from a front opening of the front end work tool 13. Conversely, the front end work tool 13 may be described as having an upward angle when the bottom surface 24 of the front end work tool 13 is tipped rearwards relative to the work machine 10 such that contents of the front end work tool 13 may be prevented from falling under gravity from the front end work tool 13.

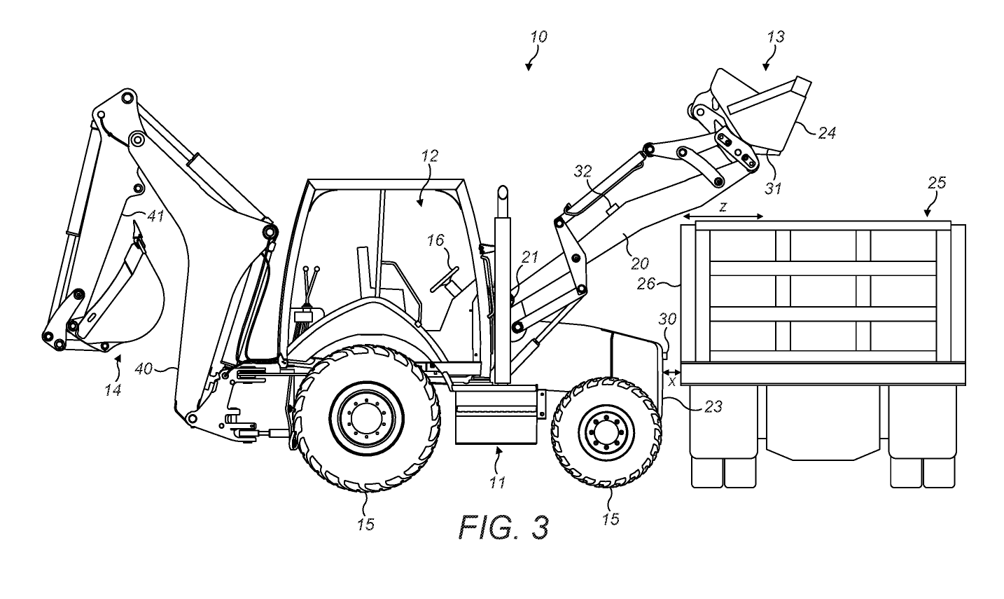

It will be appreciated that it may be challenging for the operator may be unable to judge by eye the precise location of the front end 23 of the work machine 10 or of the front end work tool 13. This may be problematic, for example, when unloading the front end work tool 13 into a container 25 (see FIG. 3), such as into a dump body of an articulated truck, where accurate positioning of the front end 23 of the work machine 10 and of the front end work tool 13 may be required to avoid spilling the load over a side of the container 25 and to prevent the front end 23 of the work machine 10 from contacting a near wall 26 of the container 25, which may cause damage to the front end 23 of the work machine 10. Similar difficulties may be encountered when unloading one or more pallets from a loader fork onto a platform.

To facilitate the positioning of the front end work tool 13 in such situations, a work tool positioning system may be provided. The system may comprise one or more sensors, a processor, and an alert system visible and/or audible to an operator in the cab 12 of the work machine 10.

The one or more sensors may comprise at least one proximity sensor 30, for providing a proximity signal indicative of a distance ‘X’ between the proximity sensor 30 (and, therefore, the front end 23 of the work machine 10) and an object in front of the proximity sensor 30. For example, the proximity sensor 30 may provide a proximity signal indicative of a distance between the proximity sensor 30 and a near wall 26 of a container 25. The proximity sensor 30 may be provided on the front end 23 of the work machine 10. In one embodiment of the disclosure, two or more sensors may be provided on the front end 23 of the work machine 10. The at least one proximity sensor 30 may be configured to activate when the pair of arms 20 is raised at or above an angle such that the front end work tool 13 itself will not be detected by the proximity sensor 30. This angle may be specific to each combination of model of work machine with a selected front end work tool, and may be calibrated as required. As a non-limiting example, the angle may be selected from a range of 0.5° to 3.5° above a horizontal plane, more preferably 1.2° to 3.1° above a horizontal plane. Alternatively, a greater angle may be selected such that it may be suitable for any combination of work machine and front end work tool, for example 10°.

The processor (not shown) may be configured to receive the proximity signal from the at least one proximity sensor 30 and to determine an event. The event may be a positive event or a negative event. The processor may further be configured to alert an operator in the cab 12 to an event via the alert system. A particular alert or combination of alerts may be associated with each different event.

The alert system may comprise at least one means for alerting an operator in the cab 12 to an event. The alert system may comprise means to provide an audible alert. For example, the means to provide an audible alert may comprise a speaker. Alternatively or additionally, the alert system may comprise means to provide at least one visible alert 32 visible to the operator in the cab 12. For example, the means to provide at least one visible alert 32 may be an alert light located in the cab 12 and/or on the pair of arms 20. Alternatively or additionally, the means to provide a visible alert 32 may comprise a display panel in the cab 12.

An example of a positive event may be the correct positioning of the front end work tool 13 for unloading into a container 25 (see FIG. 3). The processor may receive the proximity signal indicative of the distance X between the proximity sensor 30 (and, therefore, the front end 23 of the work machine 10) and the near wall 26 of the container 25. The processor may calculate a distance ‘Y’ between a reference location on the front end work tool 13, for example a location on the rear surface 31 of the front end work tool 13, and the front end 23 of the work machine 10, based on the angle of the pair of arms 20 (since the pair of arms 20 has a known length). The processor may calculate a clearance distance ‘Z’ between the reference location on the front end work tool 13 and the near wall 26 of the container 25, where Z may be substantially equal to Y minus X. If a display panel is provided, a live display of the clearance distance Z may appear on the display panel to aid the operator in positioning the front end work tool 13. The processor may be configured to activate one or more positioning alerts when the front end work tool 13 is in a suitable position for unloading, which may be when the clearance distance Z is greater than or equal to a first threshold unloading distance Z₁. For example, a predetermined audible alert may sound, and/or a visible alert 32 may be activated, and/or an alert message may appear on the display panel. As a non-limiting example, the first threshold unloading distance Z, may be selected from a range of from 600 mm to 1100 mm, more preferably 740 mm to 940 mm.

In some cases, such as when unloading materials that may flow easily (such as, for example, dry soil), a substantially even and complete fill of the container 25 may be obtained from unloading the front end work tool 13 repeatedly at a single suitable unloading position. For example, the single suitable unloading position may be substantially above the centre of the container 25. In such cases, the processor may be programmed with a single first threshold unloading distance Z₁. In other cases, such as when unloading materials that may not flow easily (such as, for example, rocks), unloading the front end work tool 13 repeatedly at a single unloading position may result in an uneven and incomplete filling of the container 25. By instead unloading from the front end work tool 13 at a plurality of suitable unloading positions, a more even and complete fill of the container 25 may be obtained. For example, the plurality of suitable unloading positions may be substantially above the near side, centre, and far side of the container 25. In such cases, the processor may be programmed with a plurality of first threshold unloading distances Z₁, The processor may be configured to activate one or more different positioning alerts for each of the plurality of first threshold unloading distances Z₁, so that the operator may distinguish between the plurality of suitable unloading positions. Alternatively, the processor may be configured to cycle consecutively between the plurality of first threshold unloading distances Z₁ for consecutive loads. The processor may be configured to receive as an input (for example, via the display panel) identifying information to enable the processor to select or calculate one or more suitable first threshold unloading distances Z₁. For example, the identifying information may comprise the type of materials (such as, for example, dry soil, rocks, etc.), a category of materials (such as, for example, free-flowing, semi-free-flowing, non-free-flowing, etc.), the width of the container 25, etc.

The processor may additionally activate one or more modified positioning alerts when the clearance distance Z is less than the first threshold unloading distance Z, but greater than or equal to a second threshold unloading distance Z₂, to indicate that the front end work tool 13 is approaching a suitable position for unloading. The second threshold unloading distance may, as a non-limiting example, be a distance of 0 mm (i.e. when the reference location on the front end work tool 13 is level with the near wall 26 of the container 25). Alternatively, as a further non-limiting example, the second threshold unloading distance Z₂ may be selected from a range of from 125 mm to 625 mm, more preferably 275 mm to 475 mm.

The one or more positioning alerts may vary in direct proportion to distance, between the second threshold unloading distance Z₂ and the first threshold unloading distance Z₁. For example, the positioning alert at the second threshold unloading distance Z₂ may comprise an audible alert having one pulse (or ‘beep’) per second, which may vary with distance in a directly proportional manner to an audible alert having five pulses per second at the first threshold unloading distance Z₁.

The processor may include a database of the optimum second threshold unloading distance Z₂ and first threshold unloading distance Z, for various options of front end work tool 13. The processor may further be configured to receive as an input (for example, via the display panel) the type of front end work tool 13 which is in use, such that the database may select the optimum second threshold unloading distance Z₂ and first threshold unloading distance Z₁ for that specific front end work tool 13.

An example of a negative event may be impending contact between the front end 23 of the work machine 10 and an object, such as the near wall 26 of the container 25. Again, the processor may receive the proximity signal indicative of the distance X between the proximity sensor 30 (and, therefore, the front end 23 of the work machine 10) and the near wall 26 of the container 25. The processor may be configured to activate one or more contact alerts when the proximity signal corresponds to a distance X which is less than or equal to a first threshold contact distance X₁. For example, a predetermined audible alert may sound, and/or a visible alert 32 may be activated, and/or an alert message may appear on the display panel. As a non-limiting example, the first threshold contact distance X₁ may be selected from a range of from 400 mm to 1000 mm, more preferably 550 mm to 850 mm. The processor may further be configured to activate one or more modified contact alerts when the proximity signal corresponds to a distance X which is less than or equal to a second threshold contact distance X₂, which may be smaller than the first threshold contact distance X₁. As a non-limiting example, the second threshold contact distance X₂ may be selected from a range of from 75 mm to 250 mm, more preferably 125 mm to 200 mm. The one or more contact alerts may vary in direct proportion to distance, between the first threshold contact distance X₁ and the second threshold contact distance X₂. For example, the contact alert at the first threshold contact distance X₁ may comprise an audible alert having one pulse (or ‘beep’) per second, which may vary with distance in a directly proportional manner to an audible alert having five pulses per second at the second threshold contact distance X₂. The processor may be configured to activate the brakes of the work machine 10 when the proximity signal corresponds to a distance X which is less than or equal to the first threshold contact distance X₁ and/or the second threshold contact distance X₂. The processor may be configured to activate the alert system only when the work machine 10 is moving forwards; if the work machine 10 is stationary or reversing the alert system may be deactivated.

The work tool positioning system may also be applied to a rear end work tool 14, which may also be used at times for loading materials into a container 25. The rear end work tool 14 is typically connected to the body 11 of the work machine 10 via a boom 40 and a stick 41. To adapt the work tool positioning system to a rear end work tool 14, the at least one proximity sensor 30 maybe provided on the boom 40.

### INDUSTRIAL APPLICABILITY

The work tool positioning system and method has industrial applicability in the field of work machines, and particularly in the field of loaders. The present disclosure finds application in improving the efficient use of a work machine 10, particularly though not exclusively by an inexperienced user.

In use, an operator of the work machine 10 may use the front end work tool 13 to pick up materials, and to transport the materials to a container 25 into which the materials are intended to be unloaded. To suitably position the loader bucked 13 for unloading the materials into the container 25, the front end 23 of the work machine 10 may approach the near wall 26 of the container 25. One or more positioning alerts may be activated when the clearance distance Z is greater than or equal to the second threshold unloading distance, to indicate that the front end work tool 13 is approaching a suitable position for unloading. One or more modified positioning alerts may then be activated when the clearance distance Z is greater than or equal to the first threshold unloading distance, to indicate that the front end work tool 13 has reached a suitable position for unloading.

If the distance X between the proximity sensor 30 (and, therefore, the front end 23 of the work machine 10) and the near wall 26 of the container 25 becomes less than or equal to a first threshold contact distance, one or more contact alerts may be activated to indicate that the front end 23 of the work machine 10 is very close to the near wall 26 of the container 25. One or more modified contact alerts may be activated if the distance X becomes less than or equal to the second threshold contact distance, to indicate to the operator that the work machine 10 should not move any closer to the near wall 26 of the container 25. Additionally and alternatively, the brakes may automatically be applied. The contact alerts may cease when the work machine 10 becomes stationary or reverses.

In this way, an operator of the work machine 10, in particular an inexperienced operator of the work machine 10, may be provided with sufficient information to approach a container 25 or a platform to a very close distance, to achieve an optimal position of the front end work tool 13 to successfully unload the front end work tool 13 into the container 25 or onto the platform without spilling/dropping the load, and without damaging the front end 23 of the work machine 10.

1. A work tool positioning system for a work machine comprising a movable work tool, the work tool positioning system comprising:
a work tool mounted at an end of a movable arm;
at least one proximity sensor for providing a proximity signal indicative of a distance between the at least one proximity sensor and an object in front of the proximity sensor;
a processor configured to receive the proximity signal and to calculate a clearance distance between a reference location on the work tool and an object in front of the proximity sensor; and
an alert system for alerting an operator of the work machine; wherein
the processor is configured to activate one or more alerts when the clearance distance is greater than or equal to a first threshold unloading distance.

2. A work tool positioning system according to claim 1, wherein the processor is further configured to activate one or more alerts when the clearance distance is greater than or equal to a second threshold unloading distance, wherein the second threshold unloading distance is smaller than the first threshold unloading distance.

3. A work tool positioning system according to claim 2, wherein the one or more alerts vary in direct proportion to distance, between the second threshold unloading distance and the first threshold unloading distance.

4. A work tool positioning system according to claim 1, wherein the processor is further configured to activate one or more alerts when the proximity signal corresponds to a distance which is less than or equal to a first threshold contact distance.

5. A work tool positioning system according to claim 4, wherein the processor is further configured to activate one or more alerts when the proximity signal corresponds to a distance which is less than or equal to a second threshold contact distance, wherein the second threshold contact distance is smaller than the first threshold contact distance.

6. A work tool positioning system according to claim 5, wherein the one or more alerts vary in direct proportion to distance, between the first threshold contact distance and the second threshold contact distance.

7. A work tool positioning system according to claim 4, wherein the processor is further configured to activate a braking system of the work machine when the proximity signal corresponds to a distance which is less than or equal to the first threshold contact distance and/or the second threshold contact distance.

8. A work tool positioning system according to claim 1, wherein the at least one proximity sensor is activated when the movable arm is raised to an angle such that the work tool itself will not be detected by the at least one proximity sensor.

9. A work tool positioning system according to claim 1, wherein the at least one proximity sensor is located at a front end of the work machine.

10. A work tool positioning system according to claim 1, comprising two or more proximity sensors.

11. A work tool positioning system according to claim 1, wherein the alert system comprises means to provide an audible alert.

12. A work tool positioning system according to claim 1, wherein the alert system comprises means to provide at least one visible alert.

13. A work tool positioning system according to claim 1, wherein the alert system comprises a display panel.

14. A work tool positioning system according to claim 1, wherein the work tool comprises a loader bucket.

15. A work tool positioning system according to claim 1, wherein the work tool comprises a loader fork.
